(19) United States
(12) Patent Application Publication
(10) Pub. No.: US 2024/0025285 A1
(43) Pub. Date: Jan. 25, 2024

(54) MOBILE ELECTRIC VEHICLE WIRELESS CHARGING

(71) Applicant: AT&T Intellectual Property I, L.P., Atlanta, GA (US)

(72) Inventors: Howard L. Lang, Wayside, NJ (US); Joseph Soryal, Glendale, NY (US); Naila Jaoude, Eatontown, NJ (US)

(21) Appl. No.: 17/871,188

(22) Filed: Jul. 22, 2022

(51) Int. Cl. B60L 53/38; B60L 53/57; B60L 53/66; B60L 53/12; B60L 53/68

(52) U.S. Cl. CPC B60L 53/38; B60L 53/57; B60L 53/66; B60L 53/12; B60L 53/68

(57) ABSTRACT

A processing system including at least one processor of a first surface-operating vehicle may obtain a request for wireless charging of a second surface-operating vehicle while in motion. The processing system may then navigate the first surface-operating vehicle in synchronization with the second surface-operating vehicle and provide the wireless charging to the second surface-operating vehicle while in motion.

The present disclosure relates generally to electric-powered vehicle operations, and more particularly to methods, computer-readable media, and apparatuses for navigating a first surface-operating vehicle in synchronization with a second surface operating vehicle to provide wireless charging to the second surface-operating vehicle while in motion.

### BACKGROUND

Electric vehicles (EVs) are becoming increasingly popular with consumers. However, EV range is limited by capacity of on-board batteries. As such, users of EVs may experience “range anxiety,” e.g., fear of running out of power without being able to locate a charging station, having to prolong a trip to account for the time to recharge the battery, or to divert off a most direct route to reach a charging station.

### SUMMARY

In one example, the present disclosure describes a method, computer-readable medium, and apparatus for navigating a first surface-operating vehicle in synchronization with a second surface operating vehicle to provide wireless charging to the second surface-operating vehicle while in motion. For example, a processing system including at least one processor of a first surface-operating vehicle may obtain a request for wireless charging of a second surface-operating vehicle while in motion. The processing system may then navigate the first surface-operating vehicle in synchronization with the second surface-operating vehicle and provide the wireless charging to the second surface-operating vehicle while in motion.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of an example method for navigating a first surface-operating vehicle in synchronization with a second surface operating vehicle to provide wireless charging to the second surface-operating vehicle while in motion; and

FIG. 3 illustrates an example high-level block diagram of a computing device specifically programmed to perform the steps, functions, blocks, and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for navigating a first surface-operating vehicle in synchronization with a second surface operating vehicle to provide wireless charging to the second surface-operating vehicle while in motion. Notably, electric vehicles (EVs) are becoming increasingly popular. However, range is typically limited by capacity of onboard batteries. Recharging of EVs is time consuming and may often be performed overnight while a vehicle is parked in a garage or driveway. Publicly accessible charging stations are also available, but may be out of the way, may already be in use, or may be reserved by others at desired times. In contrast, examples of the present disclosure provide for recharging of an EV while in motion, avoiding delay in a user's travel plans. For instance, in one example, an autonomous charging vehicle, which may be referred to as an intelligent mobile unit (IMU), may follow an EV while travelling to recharge the EV battery (or batteries). In one example, a fleet of IMUs may be assigned to a zone (e.g., a segment of a highway, portions of two or more intersecting highways, etc.). Accordingly, IMUs may travel back and forth along a stretch of roadway to recharge EVs. The IMUs may stop at or return to one or more designated charging stations when the IMUs are low on charge.

In the event there are more EVs seeking recharge than available IMUs, a fleet management system may assign IMUs to EVs based on various factors, e.g., determining which EVs are to be charged, in what priority, and to what level of charge, which IMUs are to service which EVs, etc. For instance, a fleet management system (e.g., a reservation system) may consider factors obtained from EVs' (and/or other vehicles') onboard units (OBUs), cameras in various areas, or other sensors. For example, the fleet management system may consider: destination factors (e.g., a low number of charging stations, expected surge of visitors, such as a Friday evening at a summer vacation destination, etc.), weather (e.g., if an EV is heading towards an area affected by snow, then it may obtain higher priority), user circumstances (e.g., some users cannot afford to wait long to receive medicine or reach important appointments), cost of charging and time of day (e.g., a scheduler component of the fleet management system may optimize where and when an EV may charge, such as reserving an IMU for the EV on a commute home from work in the evening, rather than for on the commute to work in the morning along the same stretch of highway), energy source (e.g., the fleet management system may prioritize IMUs from charging stations with clean energy over fossil energy, at the user's preference), traffic (e.g., if the EV must travel over a route that will inevitably have traffic and a faster route to the destination is not found, there may be an opportunity for a longer charging time, and hence a more full and complete charge), and so forth.

Alternatively, or in addition, an EV may request recharge from one or more other nearby EVs. The recharging activity may occur while both EVs are in motion, to eliminate any travel delay. For instance, a donor EV may coordinate travel with a recipient EV to lock speed and direction, etc. In one example, the donor EV may earn monetary credits for providing a charge. Similarly, in one example, an EV may receive various incentives for being recharged by IMUs (or other EVs) powered by clean, renewable energy sources, such as priority access to a highway lane, toll booth lane, high-occupancy vehicle (HOV) lane, etc. For instance, whenever an EV receives a clean energy-sourced charge from an IMU, the EV may be enabled to present an indicator such as a visible/invisible light transponder to gain priority access to parking lots, bridges, tunnels, high-occupancy vehicle lanes, reduced toll lanes, etc. In one example, an EV may communicate with IMUs or other EVs directly (e.g., via peer-to-peer wireless communications, e.g., according to a dedicated short range communication (DSRC) protocol or the like) to arrange for a wireless charging. Alternatively, or in addition, an EV may submit a request to a fleet management system, which may manage IMUs, and in one example may also manage/coordinate other EVs in a particular area to arrange pairings for in-motion wireless charging.

In one example, IMUs may have one or more batteries that may be charged via a charging station at a fixed location. For instance, charging stations may be located along the roads to which IMUs are assigned and may be dedicated to serve these IMUs. Alternatively, or in addition, IMUs may use any available charging stations (e.g., the same charging stations that may be similarly used by parked EVs directly). In one example, each IMU may include a wireless charging unit for wireless charging of EVs (e.g., for inductive charging and/or resonance charging). In addition, an EV that may receive charge from an IMU may also include a wireless charging unit (e.g., for inductive charging and/or resonance charging).

In one example, an EV may reserve an IMU in advance, e.g., to be ready after x minutes/hours at a location or zone along a route. Once the EV arrives to that location/zone of the road, an assigned IMU may navigate itself under the EV and travel along the EV with the same speed and direction. The IMU may then charge the EV via wireless charging. In one example, an IMU may store and/or may be provided with information (such as from a fleet management system) on how to access the EV's wireless charging unit (e.g., an exact location on the underside of the EV based on model and make of the EV) for most efficient coupling.

Once the EV is fully charged (or receives a designated amount of charge, e.g., a sufficient amount of charge to comfortably reach its intended destination, and the like), the IMU may separate from the EV to return to its designated charging station, or may go to a nearest charging station to recharge, to travel to meet a next EV on the road (e.g., if the IMU still has sufficient charge to transfer energy to the next EV), and so forth. In one example, an IMU may synchronize with an EV's onboard unit (OBU) to coordinate speed, turns, and all road reactions (e.g., cruise control actions). In one example, an IMU may have minimal height. For instance, no significant hazardous conditions may result in the event a vehicle unintentionally runs over an IMU.

Notably, examples of the present disclosure may save travel distance and overall trip time for EVs by using a mobile recharge, rather than a fixed-location charging station. In addition, EV users (e.g., drivers, passengers, etc.) may be assured that running out of charge is likely to be avoided. For instance, in one example, EVs with the greatest need may be granted appropriate priority, when mobile recharging facilities are scarce. Additionally, examples of the present disclosure may benefit the environment such as via incentives applied when using clean, renewable energy sources for recharging, as well as facilitating greater adoption of EV usage overall (e.g., in replacement of conventional internal combustion engine-powered automobiles).

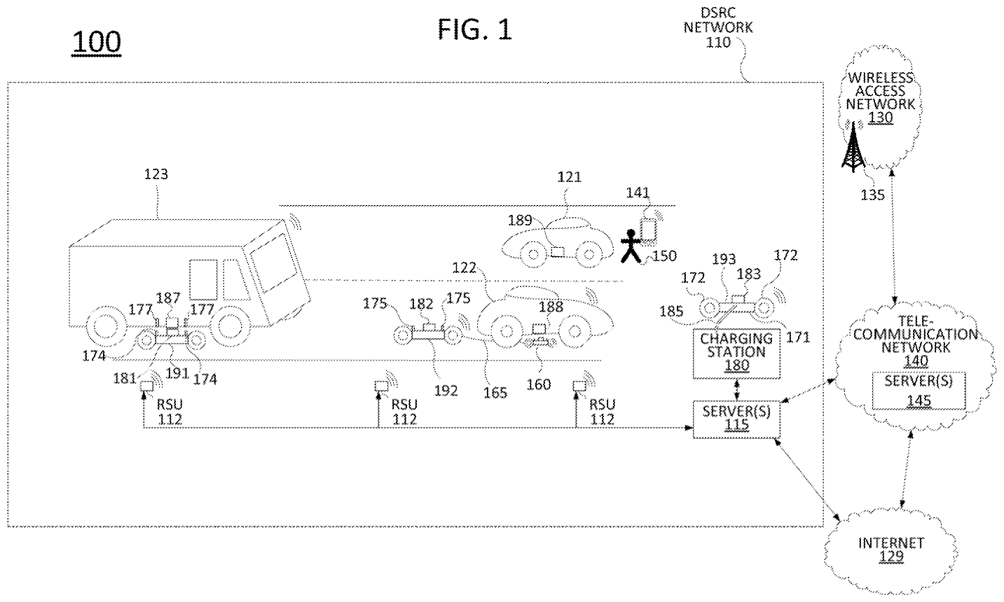

Although the present disclosure is discussed below in the context of example dedicated short range communication (DSRC) networks and cellular access networks, the present disclosure is not so limited. Namely, the present disclosure can be applied to various types of communication networks using various types of communication protocols, e.g., a combination of any one or more of: wired and wireless local area network (LANs), wide area networks (WANs), various types of cellular networks, e.g., general packet radio service (GPRS) networks, uniform terrestrial radio access networks (UTRANs), Global System for Mobile Communications (GSM) networks, Long Term Evolution (LTE) networks, Fifth Generation (5G) networks, and the like, satellite networks, the Internet in general and so forth. These and other aspects of the present disclosure are described in greater detail below in connection with the examples of FIGS. 1-3.

To aid in understanding the present disclosure, FIG. 1 illustrates an example system 100 (e.g., one or more networks) in which examples of the present disclosure may operate. In one illustrative example, the system 100 comprises a telecommunication network 140, a wireless access network 130 (e.g., a cellular access network), a dedicated short range communication (DSRC) network 110, and the Internet 129. In one example, wireless access network 130 may comprise a Universal Terrestrial Radio Access Network (UTRAN), or an evolved Universal Terrestrial Radio Access Network (eUTRAN) and the base station 135 may comprise a NodeB or an evolved NodeB (eNodeB), or may comprise a 5G radio access network, e.g., where base station 135 may comprise a gNodeB (or gNB). In one example, the telecommunication network 140 may comprise an Evolved Packet Core (EPC) network, or the like. In another example, telecommunication network 140 may comprise an IP network, a multi-protocol label switching (MPLS) network, etc. In still another example, the wireless access network 130 may comprise a basic service set and the base station 135 may comprise a base transceiver station (BTS). In other words, wireless access network 130 may comprise a second generation (2G) network, a third generation (3G) network, a fourth generation (4G) network and/or a Long Term Evolution (LTE) network, a 5G network, and so forth.

In one example, the wireless access network 130, the telecommunication network 140, and/or the DSRC network 110 may be operated by different service providers, the same service provider or a combination thereof. For example, DSRC network 110 may be operated by a governmental entity, a private entity managing a transportation region on behalf of a governmental entity, a private entity authorized to deploy and operate IMUs in an area, and so forth. On the other hand, wireless access network 130 and/or telecommunication network 140 may be operated by a telecommunications network service provider. Various interconnections between DSRC network 110, wireless access network 130, telecommunication network 140, and other components are shown. In accordance with the present disclosure, it is contemplated that various communication devices may utilize any one or a combination of such networks and interfaces in order to communicate with one another.

In one example, the internal communications of the DSRC network 110 may use a 75 MHz frequency band around 5.925 GHz assigned by the Federal Communication Commission (FCC) of the United States for Intelligent Transportation Systems, or DSRC networks. In general, DSRC networks enable wireless vehicle-to-vehicle communications and vehicle-to-infrastructure communications. DSRC networks may exist for transmitting safety and road condition information to vehicles, to warn of traffic and weather, to sense nearby vehicles (e.g., blind spot detection), and so forth. In this regard, DSRC networks contemplate an on-board unit (OBU) for DSRC-enabled vehicles to transmit, as well as to receive and display messages.

Accordingly, as illustrated in FIG. 1, DSRC network 110 may interconnect and control a number of infrastructure elements, also referred to herein as roadway resources, which include roadside units (RSUs) 112. Other infrastructure elements that are not specifically illustrated in FIG. 1 may also comprise part of the DSRC network 110, e.g., traffic lights, informational signs (e.g., road-side display screens), restricted access gate(s), and so forth. DSRC network 110 also includes one or more servers 115 for managing infrastructure elements, for communicating with other elements and for controlling other aspects of the DSRC network 110.

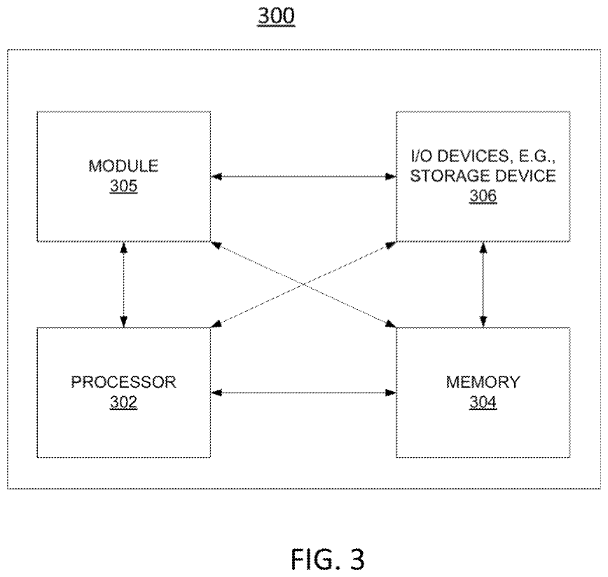

In one example, the server(s) 115 may comprise a computing system, or systems, such as one or more instances of computing system 300 depicted in FIG. 3, and may be configured to provide one or more functions in connection with examples of the present disclosure for navigating a first surface-operating vehicle in synchronization with a second surface operating vehicle to provide wireless charging to the second surface-operating vehicle while in motion. For example, server(s) 115 may be configured to perform one or more steps, functions, or operations in connection with the example method 200 described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

It should be noted that any one or more of the functions described herein with respect to the DSRC network 110 may be performed by server(s) 115 and/or a plurality of servers deployed in a distributed environment (e.g., in a “cloud-based” environment). For instance, DSRC network 110/server(s) 115 may control the timing of traffic lights, may coordinate the timing of two or more of traffic lights in a synchronized manner, and so forth. In one example, server(s) 115 may comprise a fleet management system for a fleet of surface-operating vehicles for providing mobile EV charging (e.g., which may be referred to herein as IMUs), such as IMUs 191-193. However, it should be noted that in another example, a separate fleet management system may be used, which may communicate with IMUs, EVs, etc. via DSRC network 110 (e.g., where server(s) 115 may remain dedicated to controlling RSUs 112, managing traffic flow in general, etc.). Henceforth, for illustrative purposes, various examples of the present disclosure are described in connection with steps, functions and/or operations performed by or facilitated by server(s) 115. It should also be noted that DSRC network 110 may operate in accordance with alternative or additional technologies. For instance, RSU(s) 112 may alternatively or additional comprise access points (APs) that may establish a wireless local area network (WLAN), e.g., an Institute for Electrical and Electronics Engineers (IEEE) 802.11 network (e.g., a Wi-Fi network), an IEEE 802.15, e.g., a Bluetooth network, a ZigBee network, and so forth, a mesh network comprising a combination of interconnected devices using a plurality of such communication modalities and protocols, or the like.

In addition, each of the electric vehicles (EVs) 121-123 and IMUs 191-193 (also comprising a particular type of EVs) illustrated in FIG. 1 may be equipped with an associated on-board unit (OBU) for communicating with the server(s) 115, e.g., via one or more of the RSUs 112. For example, each OBU may comprise one or more radio frequency (RF) transceivers for cellular communications and/or for non-cellular wireless communications. To illustrate, a traffic controller may provide server(s) 115 with a warning that there is a roadway hazard at an intersection, e.g., an icing condition, an accident, etc. Accordingly, the server(s) 115 may broadcast a warning message via one or more of the RSUs 112 near the intersection. In turn, the warning may be received by the OBU of any vehicle approaching the intersection to warn or instruct the driver to slow down and/or take other precautions. In one example, the OBU of each vehicle may comprise a navigation unit, or may be connected to an associated navigation unit. For example, the OBU may include a global positioning system (GPS) navigation unit that enables the driver to input a destination, and which determines the current location, calculates one or more routes to the destination, and assists the driver in navigating a selected route. In one example, the OBU may alter a current programmed route to avoid the roadway hazard at the intersection.

The OBU of each vehicle may also be equipped to communicate with other OBUs. For instance, in general, DSRC networks enable wireless vehicle-to-vehicle (V2V) communications and vehicle-to-infrastructure (V2I) communications. Thus, in one example, EVs 121-123, IMUs 191-193, and others may communicate with each other directly (e.g., without necessarily involving RSUs 112, server(s) 115, etc.). Alternatively, or in addition, in one example, the OBUs of each vehicle may be equipped for cellular communications. For instance, where coverage of the DRSC network 110 is weak or non-existent, wireless access network 130 and base station 135 may supplement the coverage to ensure that vehicles are not out of communication with each other and/or with server(s) 115. Similarly, in one example, EVs 121-123, IMUs 191-193, and others may communicate with each other directly using an LTE sidelink, a 5G sidelink, or the like. As illustrated in FIG. 1, each of EVs 121-123 may have associated users (e.g., operators/drivers and/or passengers). However, it should be noted that any one or more of EVs 121-123 may alternatively or additional comprise a self-driving, autonomous vehicle (AV), or may comprise a self-driving-capable vehicle that is operating in a self-driving/autonomous mode, e.g., where an operator/driver may disengage such feature and manually operate the vehicle at any time. For illustrative purposes, a single user 150 is illustrated in association with EV 121. However, it should be understood that vehicles 122 and 123 may similarly have one or more associated users. On the other hand, each of IMUs 191-193 may comprise an autonomous (self-operating) EV. Each autonomous vehicle (AV) (e.g., IMUs 191-193, and in one example, any one or more of the EVs 121-123) may have wireless network and/or peer-to-peer communication capabilities (e.g., including DSRC, Wi-Fi, LTE and/or 5G sidelink, etc.). Each AV may also have location awareness (e.g., GPS) and other sensing capabilities such as motion detection, radar, sonar, light detection and ranging (LiDAR), audio detection via microphones, cameras to detect and capture images or video, and so forth.

In one example, mobile device 141 may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a pair of smart glasses or goggles, and the like. In one example, mobile device 141 may have both cellular and non-cellular access capabilities. Thus, mobile device 141 may be in communication with server(s) 115 via a wireless connection to base station 135 and/or to RSU(s) 112. For instance, mobile device 141 may include one or more transceivers for cellular based communications, IEEE 802.11 based communications, IEEE 802.15 based communications, DSRC-based communications, and so forth. In one example, mobile device 141 may also be equipped to communicate directly with vehicles 122 and 123, and others, e.g., via DSRC-based communications, via an LTE sidelink, a 5G sidelink, or the like, and so forth. For instance, in one example, vehicle 121 may not be equipped with an OBU. However, mobile device 141 may participate in DSRC communications with other vehicles to provide safety awareness, to coordinate in-motion EV charging in accordance with the present disclosure, and so forth. In one example, mobile device 141 may be associated with user 150.

It should also be noted that in some examples it may be necessary or helpful to the DSRC network 110/server(s) 115 to have a lane-level accurate view of the traffic and road conditions. Accordingly, in one embodiment, server 115 may track vehicles' OBUs, mobile devices (such as mobile device 141), and so forth via RSUs 112. For instance, in addition to broadcasting and/or transmitting messages from server(s) 115 to vehicles, RSUs 112 may also interrogate OBUs of passing vehicles to determine a level of traffic, to determine which specific vehicles are travelling on the road, e.g., for toll charging and other purposes, and so forth. In one example the OBU of each vehicle may also be equipped with a Global Positioning System (GPS) unit for location sensing. In one example, the GPS using may be configured for differential GPS (DGPS) and/or real-time kinematic (RTK) location sensing. For instance, any one or more of RSUs 112, base station 135, or the like may comprise a reference receiver. Accordingly, an OBU may resolve its position with high accuracy via any one or more of: DSRC communications from RSUs 112, DGPS signals from one or more satellites, DGPS signals from one or more satellites in combination with RTK information from a reference receiver, and so forth. In particular, in one embodiment DGPS/RTK information may be used in conjunction with direct positioning information from RSUs 112 to provide redundancy and/or to provide coverage in areas where there is little to no infrastructure of DSRC network 110. However, in another example, an OBU may solely use DGPS and/or DGPS/RTK information to determine a vehicle's position. In any case, the OBU of each of vehicle may then report a determined vehicle position to the DSRC network 110/server 115. For instance, an OBU may report location via DSRC messaging to RSUs 112 and/or via cellular communications with base station 135/wireless access network 130. It should be noted that mobile devices, such as mobile device 141, may be similarly equipped and may also participate in resolving and sharing location information of mobile device 141 with server(s) 115, EVs 122 and 123, and so forth, and/or may enable mobile device locations to be determined by server(s) 115 and/or RSUs 112.

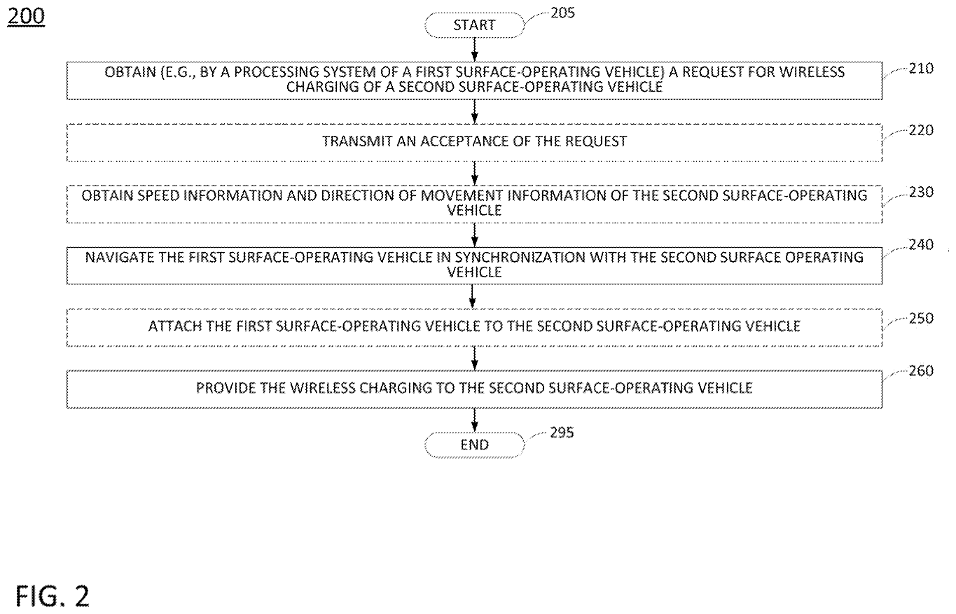

In accordance with the present disclosure, OBUs of EVs 121-123, OBUs of IMUs 191-193, and/or mobile device 141 may each comprise a computing system, or systems, such as one or more instances of computing system 300 depicted in FIG. 3, and may be configured to provide one or more functions for navigating a first surface-operating vehicle in synchronization with a second surface operating vehicle to provide wireless charging to the second surface-operating vehicle while in motion, such as illustrated in FIG. 2 and described in greater detail below in connection with the example method 200.

As illustrated in FIG. 1, each of IMUs 191-193 may comprise a chassis, at least one wheel, one or more batteries, an OBU, and a wireless charging module (e.g., one of the wireless charging modules 181-183). It should be noted that chassis 171 and wheels 172 are labeled in connection with IMU 193. For ease of illustration, similar features of IMUs 191 and 192 are not specifically labeled. However, it should be understood that IMUs 191 and 192 possess such features. In addition, for ease of illustration, batteries and OBUs are omitted from FIG. 1. However, it should be understood that each of the IMUs 191-193 may possess such components. In one example, each of the IMUs 191-193 may further include charging ports (not shown), e.g., for cable-based charging, such as via cable 185 of charging station 180.

In one example, an IMU may include a deployable charging module, such as a tethered charging module, a self-operating charging module, and/or a remote-controlled charging module. For instance, IMU 192 may possess a tethered charging module 160 that may be deployed on a roadway in the event that IMU 192 does not fit underneath a vehicle, such as EV 122. In one example, IMUs may also include one or more latches for latching onto EVs. For instance, IMU 191 may comprise latches 174 (e.g., magnetic and/or mechanical latches). Latches 174 may attach IMU 191 to vehicle 123 via latch points 177 of vehicle 123 (e.g., complementary latches, or structures configured to allow latches 174 to attach IMU 191 to vehicle 123). Similarly, IMU 192 may include latches 175. However, latches 175 may go unused, at least for some EVs, such as EV 122 which may not include such latch points, or which may be incompatible with IMU 192. For instance, IMU 192 may not fit underneath EV 122 and may deploy charging module 160 instead. Each of EVs 121-123 may similarly include a chassis, at least one wheel, at least one battery, and a wireless charging module (e.g., one of the wireless charging modules 187-189). For ease of illustration, various typical vehicle components are not specifically labeled for EVs 121-123. As noted above, in one example, each of EVs 121-123 may also an OBU (not shown). However, in another example, EV 121 may not include an OBU, but may be represented with a DSRC environment via device 141.

In an illustrative example, vehicle 123 may seek an in-motion recharge. In one example, an OBU of vehicle 123 may detect a need for recharge, or that it may be desirable to recharge, such as when discounted charging may be offered during a certain time period. For example, an availability of in-motion recharging may be broadcast via DSRC network 110. For instance, server(s) 115 may broadcast a notification of the availability of charging via IMUs in an area, e.g., via DSRC broadcast messages from RSUs 112. Alternatively, or in addition, a user (e.g., a driver of vehicle 123 and/or a passenger) may indicate a desire to obtain in-motion recharging, such as by providing a touchscreen or voice input via a user interface of an OBU of vehicle 123. In either case, a request for in-motion recharge may be transmitted to server(s) 115, e.g., via one or more DSRC communications that may be received via RSUs 112, and/or via a cellular-based communication (e.g., via base station 135, wireless access network 135, etc.). In one example, vehicle 123 may already be in an area/zone of coverage of a fleet of IMUs managed by server(s) 115 (e.g., comprising at least IMUs 191-193). In another example, vehicle 123 may be in transit and anticipated to be within the area/zone in the near future (or may have a later planned trip that may include travel through the area/zone).

In any case, server(s) 115 may determine whether the request may be fulfilled at the designated time (e.g., a current time in which the vehicle 123 is present in the area/zone, or a future time at which the vehicle 123 is anticipated to be in the area/zone). For example, server(s) 115 may consider the number of IMUs in fleet, the number of IMUs having sufficient charge available to transfer to requesting EVs, and a number of EVs requesting in-motion charging in the area/zone at or around the same time (e.g., within a given time block/time window). In one example, when the number of requesting EVs is less than the number of available IMUs, each EV may simply be assigned an IMU. For instance, each EV may be assigned a nearest IMU (e.g., if already present in the area/zone) and/or each EV may be assigned an IMU according to a scheduling algorithm that may minimize the collective travelling distances of the IMUs to meet-up with respective EVs (e.g., at the points of expected entry to the area/zone, or at other locations if the anticipated times and/or distances to complete an in-motion charging would not require spanning the entire area/zone). If there are less IMUs available than requesting EVs, server(s) 115 may then consider other factors to decide which EVs may be assigned IMUs (and which EVs may not). For instance, some EVs may specifically indicate in their requests that in-motion charging is desired, but unnecessary at the designated time. In other words, such EVs (and/or their respective users) may be willing to recharge at a different time and/or at a different location. In one example, EVs may indicate a willingness to obtain a “raincheck” and keep a currently offered cost for in-motion recharging to be used at a later time (e.g., when other EVs may be quoted a different, and possibly higher price). Thus, for example, server(s) 115 may consider these EVs first as candidates to not receive in-motion charging at the designated time period being evaluated. Similarly, EVs that have received prioritized in-motion recharging in the recent past (e.g., in the same area/zone, or a different area/zone) may be candidates for not receiving in-motion charging at the designated time period being evaluated.

Server(s) 115 may prioritize EVs based on relative levels of current charge (which may be indicated by the EVs in their respective requests submitted to server(s) 115), a number of credits (e.g., EVs may earn credits by having donated charge to IMUs or to other EVs directly in the past, by voluntarily foregoing in-motion charging at another time in the past, and so forth), a vehicle and/or user status (e.g., first responders, individuals with medical conditions, individuals with disabilities, etc. may be given priority), weather (e.g., EVs travelling into anticipated bad weather may be given priority), destinations (e.g., EVs with sufficient current charge level to reach their destinations of planned routes may have less priority than EVs that are on longer trips and have more time and/or distance remaining), destination factors (e.g., whether charging stations are widely available at an anticipated destination of an EV and/or a number of EVs anticipated to be at or near such destination (and which may be assumed to be competitors for fixed-location charging infrastructure)), traffic conditions (e.g., some EVs may need a significant quantity of charge but may pass through the area/zone quickly and may not be well served; however, if there is unavoidable traffic, the associated time delay may give an opportunity for an EV to be more fully charged, and hence to have a greater priority to being assigned an IMU), and so forth.

For illustrative purposes, it may be assumed that EV 123 is determined to have a priority level/score sufficient to be assigned an IMU. For instance, in this case, EV 123 may be assigned IMU 191. In one example, server(s) 115 may provide to IMU 191 an identification of EV 123, a location or an anticipated location of EV 123, a planned route of EV 123 (for instance, EV 123 may provide a planned route from a GPS unit of EV 123 to server(s) 115 in connection with the request), etc. As noted above, IMU 191 may comprise an autonomous vehicle (AV) that may include location awareness (e.g., GPS) and other sensing capabilities such as motion detection, radar, sonar, LiDAR, audio detection via microphones, cameras to detect and capture images or video, and so forth. As such IMU 191 may navigate itself to meet with EV 123. In one example, IMU 191 (e.g., an OBU thereof) may receive location and/or route updates of vehicle 123, e.g., from server(s) 115. In one example, IMU 191 and EV 123 may each engage in wireless sensing to detect the presence of each other. When IMU 191 and EV 123 are within sufficient range to establish direct peer-to-peer wireless communication (e.g., via DSRC or otherwise), the two entities may do so. In one example, one or both entities may periodically communicate with server(s) 115 to provide a status of an in-motion charging engagement (e.g., amount of charge transferred, amount of charge of IMU 191 remaining, current location and/or recently traveled route information, any road hazards encountered, etc.), such as via RSUs 112 and/or via wireless access network 130.

In one example, IMU 191, using its autonomous navigation abilities, may navigate itself underneath EV 123. As noted above, IMU 191 may possess and/or may be provided with information on accessing wireless charging unit 187 of EV 123 (e.g., from EV 123 itself and/or from server(s) 115). For instance, the information may include an exact location of the wireless charging unit 187, e.g., in relation to the wheel axles or one or more other reference points, may include information on latch points 177 (e.g., the existence of such location points 177, their locations and/or configuration, etc.), and so forth.

As such, IMU 191 may position itself underneath EV 123. In one example, IMU 191 may also secure itself to EV 123, e.g., via latches 174 attaching to latch points 177. For instance, latches 174 may comprise magnetic latches and/or mechanical latches, and latch points 177 may correspondingly comprise magnetic units (e.g., electromagnets that may be turned on and off, fixed magnetic material, etc.), or physical structures that may be mechanically attached to by latches 174. Thus, for example, IMU 191 may lift itself off of the roadway or may be pulled along by EV 123, e.g., without continuing to self-propel itself along the roadway. The wireless charging unit 181 of IMU 191 may be brought into contact with wireless charging unit 187 of EV 123, or within sufficiently close range so as to enable inductive charging of a battery of EV 123 by wireless charging unit 187 via a magnetic field generated by wireless charging unit 181 of IMU 191. It should be noted that in one example, the inductive charging may comprise resonant charging, which may be considered as an example of an inductive charging technique (e.g., depending upon the particular configuration(s) of wireless charging unit 181 and/or wireless charging unit 187).

Continuing with the present example a charging may be complete when a pre-agreed amount of charging is provided (e.g., the battery or batteries of EV 123 reach a threshold or target charge level, the battery or batteries of IMU 191 are depleted to a threshold or target charge level, a time duration of the in-motion charging reaches a threshold time limit, a distance threshold is reached (e.g., IMU 191 may travel to an end of a permitted area (maximum range)), etc., and/or when EV 123 or a user thereof provides an indication to end charging (for instance the user may desire to make an unplanned stop and exit a highway), and so forth. In any case, when the charging is considered complete, IMU 191 may disengage from EV 123, such as by disconnecting latches 174 from latch points 177, and may navigate out from underneath EV 123. In one example, OBUs of IMU 191 and EV 123 may remain in communication such that EV 123 may communicate speed, lane changes, turns, etc. in real-time or near-real time allowing IMU 191 to extract itself from underneath EV 123 without interference. In one example, IMU 191 may then be assigned to a next EV that has requested in-motion charging, may return to a fixed-location charging station to itself be recharged (e.g., charging station 180), may be instructed to proceed to a closest safe waiting location and/or to another waiting location, or may determine to proceed to a waiting location in its own determination, and so forth.

To further illustrate aspects of the present disclosure, FIG. 1 includes a second scenario in which IMU 192 may be assigned to EV 122. In this case, IMU 192 may not be capable of fitting underneath EV 122. However, IMU 192 may be equipped with charging module 160 (e.g., an example of a tethered charging module that may remain connected to and controlled by IMU 192 via tether 165 (e.g., a communication cable with an exterior telescopic rod structure, such as an extended universal serial bus (USB) cable or the like). In one example, charging module 160 may be similar to IMU 192 (e.g., having a chassis, wheels, etc.), but on a smaller scale and may deliver charge from a battery, or batteries of IMU 192 to wireless charging pad 188 of EV 122. In other words, charging module 160 may itself comprise a wireless charging pad for inductive charging. To facilitate in-motion charging over extended distances, an OBU of IMU 192 may establish and remain in communication with an OBU of EV 122 for a duration of the wireless charging (as well as some time before and after to enable IMU 192 to approach and synchronize navigation with EV 122 and to safely navigate away from EV 122). Thus, for example, OBUs of IMU 192 and EV 122 may remain in communication such that EV 122 may communicate speed, lane changes, turns, etc. in real-time or near-real time allowing IMU 192 closely follow EV 122 without interfering with EV 122 or other vehicles on the road. When the charging is considered complete, IMU 192 may disengage from EV 122, such as by retracting charging module 160 and tether 165, and ceasing to maintain synchronized navigation.

As noted above, an IMU may have minimal height. For instance, no hazardous conditions may result in the event a vehicle runs over an IMU. However, it is expected that an IMU may operate as any other AVs on the road and may follow all traffic rules, respond properly to traffic lights or other traffic signals, activate turn signals for turns and lane changes, activate brake lights for braking maneuvers, and so forth. Likewise, other vehicles on the road may expect that an IMU will operate as such. Thus, other vehicles may be expected to properly yield when an IMU may have a right of way, may be expected to follow an IMU along a highway at an appropriate following distance, and so forth. In one embodiment, a dedicated in-motion charging lane may be provided on a particular stretch of roadway where only in-motion charging vehicles (e.g., IMUs and currently charging EVs) may traverse.

To further illustrate aspects of the present disclosure, FIG. 1 includes a third scenario in which EV 121 may not be a direct participant in reserving in-motion charging. For instance, user 150 may reserve in-motion charging for EV 121, such as by making a reservation with server(s) 115 using mobile device 141. In one example, an IMU may be assigned to provide in-motion charging to EV 121 and may track and synchronize navigation with EV 121 via mobile device 141. For instance, user 150 may authorize the location of mobile device 141 to be provided to server(s) 115 and for mobile device 141 to be tracked. Thus, an assigned IMU may approach the general vicinity of EV 121 based on the location information of mobile device 141. Thereafter, the assigned IMU may localize mobile device 141 to a particular vehicle, and may then navigate itself underneath EV 121 to access wireless charging unit 189, for example, using local sensing capabilities such as motion detection, radar, sonar, LiDAR, audio detection via microphones, cameras to detect and capture images or video, and so forth.

The foregoing illustrates just several scenarios of how the system 100 may support examples of the present disclosure for navigating a first surface-operating vehicle in synchronization with a second surface operating vehicle to provide wireless charging to the second surface-operating vehicle while in motion. Accordingly, it should be noted that various other operations may be included in various examples. For instance, in another example, any one or more of IMUs 191-193 may communicate directly with EVs that may request in-motion charging. For instance, EV 121 may broadcast a request to any nearby IMUs (e.g., via DSRC peer-to-peer broadcast, Wi-Fi broadcast, or the like). One or more IMUs may respond, and in one example, may coordinate with each other to determine which IMU may fulfill the request. In one example, IMUs may operate independently. For instance, individual users may own and make IMUs available for use by passing EVs. An IMU may be configured to recharge at a user's home, for example, and to return to a zone/area to perform in-motion charging tasks on an ongoing basis. In such case, the IMU may earn money or other credits, e.g., for an individual owner. In one example, IMUs may report the acceptance and/or completion of an in-motion charging request to server(s) 115 (e.g., whether the IMU is managed by server(s) 115 as a fleet management system or to earn credits as an independent participant of an in-motion charging service).

Similarly, in one example, EVs may also comprise independent participants in an in-motion charging service. In other words, EVs may be both recipients and donors of charge. For instance, EVs may also include deployable charging modules, such as charging module 160 of IMU 192. As such, EVs may arrange (e.g., via communication between respective OBUs) to synchronize navigation with each other for one EV to provide charge to another EV through a deployable charging module of the donor EV and a wireless charging module of the recipient EV. Similarly, an EV may be a donor of charge to an IMU. Thus, these and other features are all contemplated within the scope of the present disclosure.

As further illustrated in FIG. 1, telecommunication network 140 also includes a server 145, which may perform the same or similar functions to server 115 in DSRC network 110. For example, DSRC network 110 may comprise just one portion of a region through which an EV may travel on a trip. For example, the route of an EV may cross from one state to another having different areas/zone in which IMUs may be managed by different servers. However, the respective servers of different zones may also be integrated into a larger system in which in-motion charging of EVs is distributed across various zones/regions, and in which the usage of EVs is tracked and accounted for consistently. Thus, in one example a telecommunications service provider, e.g., the operator of telecommunication network 140 and/or wireless access network 130, may implement functions of any one or more of the examples described herein. For example, server 145 may determine one or more local areas/zones traversed by an EV's planned route, the associated DSRC network(s) and/or fleet management servers for IMUs and/or other EVs participating in in-motion charging, and so forth. The server 145 may then transmit EV charging requests to one or more fleet management systems along the EV's route, may obtain offers from the fleet management system(s) and may assess one or more opportunities for in-motion charging along the route, may select one (or more) of such opportunities, and so forth.

The above system 100 is described to provide an illustrative environment in which examples of the present disclosure may be employed. In other words, the system 100 is merely illustrative of one network configuration that is suitable for implementing examples of the present disclosure. Thus, the present disclosure may also include any other different network configurations that are suitable for implementing embodiments of the present disclosure. For example, wireless access network 130 may comprise a wide area network (WAN), a series of LANs and so forth. Similarly, as illustrated in FIG. 1, DSRC network 110 may interconnect infrastructure elements in the 5.9 GHz DSRC band. However, the present disclosure is not limited to any specific protocol, such as DSRC, or any particular communication medium, e.g., the particular 5.9 GHz frequency band. For example, communications between OBUs and RSUs may involve radio frequency identification (RFID) interrogation, or other forms of wireless communication. In addition, DSRC network 110 may include wired portions for connecting infrastructure elements to each other, to server(s) 115 and so forth. In one example, RSUs 112 may be integrated into other infrastructures, such as traffic lights, street lights, and so forth. In still another example, the OBU of a vehicle may instead comprise a cellular telephone, a smart phone or other portable devices which are removable from the vehicle and which support additional functions besides DSRC messaging. Thus, networks including the above modifications and/or various additional modifications of the same or a similar nature are all included within the scope of the present disclosure.

FIG. 2 illustrates a flowchart of an example method 200 for navigating a first surface-operating vehicle in synchronization with a second surface operating vehicle to provide wireless charging to the second surface-operating vehicle while in-motion. In one example, steps, functions and/or operations of the method 200 may be performed by a device or system as illustrated in FIG. 1, e.g., by a device or system of an electric vehicle (EV), such as an OBU, or any one or more components thereof of one of IMUs 191-193 or EVs 121-123. Alternatively, or in addition, the steps, functions and/or operations of the method 200 may be performed by a processing system collectively comprising a plurality of devices as illustrated in FIG. 1, such as an OBU of one of IMUs 191-193 or EVs 121-123, devices or computing/processing systems of various other entities, and so forth. In one example, the steps, functions, or operations of method 200 may be performed by a computing device or processing system, such as computing system 300 and/or hardware processor element 302 as described in connection with FIG. 3 below. For instance, the computing system 300 may represent any one or more components of the system 100 that is/are configured to perform the steps, functions and/or operations of the method 200. Similarly, in one example, the steps, functions, or operations of the method 200 may be performed by a processing system comprising one or more computing devices collectively configured to perform various steps, functions, and/or operations of the method 200. For instance, multiple instances of the computing system 300 may collectively function as a processing system. For illustrative purposes, the method 200 is described in greater detail below in connection with an example performed by a processing system. The method 200 begins in step 205 and proceeds to step 210.

At step 210, the processing system (e.g., of a first surface-operating vehicle, such as an EV (e.g., an IMU, or another type of human-operated or autonomous EV)) may obtain a request for wireless charging of a second surface-operating vehicle (e.g., another EV) while in motion. In one example, the request may be received from the second surface-operating vehicle. In another example, the request may be received from another entity, such as from a fleet management system that coordinates EV-to-EV in-motion charging. For instance, the first-surface operating vehicle may be one of a fleet of surface-operating vehicles for providing in-motion wireless charging. For example, in such case, the second surface-operating vehicle may notify the fleet management system of a desire to obtain an in-motion charge. The fleet management system may then transmit the request to the first surface-operating vehicle. In one example, the fleet management system may select the first surface-operating vehicle from among the fleet for providing in-motion charging to the second surface-operating vehicle.

In one example, the request may include information for navigating the first surface-operating vehicle to synchronize with the second surface-operating vehicle. For instance, this may include location or anticipated location information of the second surface-operating vehicle, a route, speed, direction, etc. of the second surface-operating vehicle, and so forth. In one example, the first surface-operating vehicle may be assigned to a designated zone associated with at least one roadway, where the second surface-operating vehicle is within the zone or is anticipated to be in the zone at a future time (e.g., based on a planned route of the second surface-operating vehicle, etc.). In one example, the request may include information for accessing a wireless charging unit of the second surface-operating vehicle. For instance, this may include a location on an underside of the second surface-operating vehicle in relation to one or more markers, such as wheels, wheel axles, etc. Information on the ground clearance of the vehicle, wheelbase, etc. In one example, the first surface-operating vehicle may comprise an autonomous EV, such as an IMU, or an autonomous EV that may carry passengers and/or cargo and that possesses a deployable charging unit for providing charge to and/or receiving charge from another EV while in motion via inductive charging. In this regard, the second surface-operating vehicle may similarly comprise an EV that may be autonomous and/or driver-operated and that includes a wireless charging module for providing charge to and/or receiving charge from another EV while in motion via inductive charging. In addition, both the first surface-operating vehicle and the second surface-operating vehicle may each comprise one or more batteries for storing charge/energy

At optional step 220, the processing system may transmit an acceptance of the request. For instance, the acceptance may be transmitted to the second surface-operating vehicle and/or to the fleet management system. In one example, the first surface-operating vehicle may operate semi-independently from a fleet management system and may pick and choose assignments, may be granted permission to accept assignments by an owner or manager of the first surface-operating vehicle (which may be different from the fleet management system), and so forth. In another example, the first surface-operating vehicle may be controlled by the fleet management system, where the acceptance of the request may comprise an acknowledgement/confirmation that the assignment has been received and will be fulfilled.

It should be noted that in another example, the first surface-operating vehicle may transmit a message (e.g., to the fleet management system and/or the second surface-operating vehicle) denying the request. For instance, the first surface-operating vehicle may decline based upon its own programmed evaluation criteria or based upon a manual selection by an owner and/or operator. Similarly, the first surface-operating vehicle may deny the request when it has a condition that may prevent the fulfillment of the request. For instance, the first surface-operating vehicle may have a braking or wheel problem that a fleet management system was not previously aware of.

At optional step 230, the processing system may obtain speed information and direction of movement information of the second surface-operating vehicle. For instance, in one example, the processing system may receive speed information and direction of movement information from the second surface-operating vehicle (e.g., directly via peer-to-peer wireless communication or the like). In another example, the speed information and direction of movement information may be received from an intermediary entity, such as fleet management system or the like.

At step 240, the processing system navigates the first surface-operating vehicle in synchronization with the second surface operating vehicle (e.g., along a road, or one or more roads). In one example, the navigating comprises matching a speed and a direction of movement of the second surface-operating vehicle. For instance, the speed and direction of movement may be obtained at optional step 230 (e.g., from the second surface-operating vehicle or from another intermediary entity, such as a fleet management system, or the like). Alternatively, or in addition, the processing system may use local sensing capabilities such as motion detection, radar, sonar, LiDAR, cameras, and so forth to enable proper positioning of the first surface-operating vehicle in relation to the second surface-operating vehicle. In one example, the navigating at step 240 may include controlling the first surface-operating vehicle into a position underneath the second surface-operating vehicle.

At optional step 250, the processing system may attach the first surface-operating vehicle to the second surface-operating vehicle, if an attachment mechanism is available. For instance, the first surface-operating vehicle may be attached to the second surface-operating vehicle via at least one latch. The latch may comprise, for example, at least one mechanical latch or at least one magnetic latch that may be actuated by the processing system. In one example, the second surface-operating vehicle may include one or more complementary latch points to allow the at least one latch to attach the first surface-operating vehicle to the second surface-operating vehicle. Although the foregoing describes examples in which EVs may include wireless charging modules on a underside of a chassis, in other, further, and different example, EVs may present wireless charging modules at one or more other locations, such as on or near a rear bumper, a tailgate, and so forth.

At step 260, the processing system provides the wireless charging to the second surface-operating vehicle. In one example, the first surface-operating vehicle may be positioned underneath the second surface-operative vehicle during the providing of the wireless charging. For instance, the navigating at step 240 may include controlling the first surface-operating vehicle into a position underneath the second surface-operating vehicle. In one example, the dimensions of the first surface-operating vehicle are configured such that the first surface-operating vehicle may fit under most passenger automobiles based on minimum wheel base (length), vehicle width (accounting for tire widths), and ground clearance, or based on a certain class of automobiles, etc. For instance, a length of the first surface-operating vehicle may be less than ten feet, a width of the first surface-operating vehicle may be less than 7 feet, a height of the first surface-operating vehicle may be less than 12 inches (e.g., which may correspond to the space underneath a large sport utility vehicle), or the like. It should be noted that actual dimensions may be smaller so as to fit underneath a smallest, widely-available passenger vehicle, such as a “compact sedan” or “economy” size vehicle, e.g., no more than six inches high, no more than 4 feet long, no more than 2 feet wide, etc.

In one example, the first surface-operating vehicle may be attached to the second surface operating vehicle during the providing of the wireless charging. For instance, this may be the case in an example in which the method 200 includes a performance of optional step 250. Alternatively, in one example, the second surface-operating vehicle may effect the attaching, e.g., by picking up the first surface-operating vehicle after the first surface-operating vehicle may be navigated underneath the second surface-operating vehicle at step 240. In another example, the first surface-operating vehicle (e.g., the processing system, which may comprise an OBU) may remain in communication with the second surface-operating vehicle (e.g., via OBU-to-OBU DSRC or other peer-to-peer wireless communications) to share navigation/movement information. As such, the processing system may cause the first surface-operating vehicle to move in synchronization with the second surface-operating vehicle, thus maintaining a relative position underneath the second surface-operating vehicle. However, in another example, the first surface-operating vehicle may lead or follow the second surface-operating vehicle during the providing of the wireless charging (while remaining in communication to synchronize movements). For instance, the first surface-operating vehicle may possess a deployable charging module, where step 260 may include deploying the charging module. For instance, the charging module may comprise a tethered charging module, a remote-controlled charging module, or a self-operating charging module, and may be positioned underneath the second surface-operating vehicle to provide the wireless charging via the wireless charging unit of the second surface operating vehicle.

Following step 260, the method 200 proceeds to step 295. At step 295, the method 200 ends.

It should be noted that the method 200 may be expanded to include additional steps, or may be modified to replace steps with different steps, to combine steps, to omit steps, to perform steps in a different order, and so forth. For instance, in one example the processing system may repeat one or more steps of the method 200 for a different EV/surface-operating vehicle after completion of the in-motion wireless charging of the second surface operating vehicle. In one example, the first surface-operating vehicle may receive inductive charging from the second surface-operating vehicle. For instance, the first surface-operating vehicle may be an IMU that may be short on charge, but there may be many EVs that are requesting in-motion charging. Thus, another EV with an excess of charge may transfer charge to the first surface-operating vehicle, which may then be available for transfer to other EVs (e.g., other surface-operating vehicles). For instance, this may be safer than two human-operated EVs transferring directly between each other. In one example, the method 200 may be expanded to include monitoring a charge level of one or more batteries of the first surface-operating vehicle, determining whether the charge level is sufficient, and navigating to a fixed-location charging station to recharge when the charge level is not sufficient (e.g., insufficient for engaging in in-motion charging of additional EVs while retaining a reserve to reach a fixed-location charging station). In one example, the second surface-operating vehicle may include a deployable charging module and may release such a charging module for inductive pairing with the wireless charging module of the first surface-operating vehicle, which may be following behind the second surface-operating vehicle.

In one example, the method 200 may be expanded to include, or may alternatively comprise operations of a fleet management system (e.g., a processing system including at least one processor, such as one or more servers). For instance, in such an example, the method 200 may further include, or another method may comprise: obtaining (e.g., by a processing system including at least one processor) a request for a wireless charging of a first surface-operating vehicle while in motion, determining, by the processing system, a priority for the first surface-operating vehicle in accordance with a plurality of factors associated with the first surface-operating vehicle, and transmitting, by the processing system, an instruction to a second surface-operating vehicle to provide the wireless charging to the first surface-operating vehicle while in motion. As noted above, the plurality of factors may comprise any one or more of: a charge level of the first surface-operating vehicle, a planned route of the first surface-operating vehicle, a cost of the wireless charging, a number of available surface-operating vehicles of a fleet of surface-operating vehicles for providing wireless charging, a demand for wireless charging from one or more other surface-operating vehicles, a weather condition, a traffic condition, destination factors (e.g., a number of fixed-location charging stations that may be available at or near a destination, etc.), and so forth.

In one example, the instruction may comprise information for navigating the second surface-operating vehicle to synchronize with the first surface-operating vehicle, such as described above in connection with step 210 and/or optional step 230 (e.g., a location or anticipated location of the first surface-operating vehicle, a route, speed, direction, etc. of the first surface-operating vehicle, and so forth). Similarly, the instruction may comprise information for accessing a wireless charging unit of the first surface-operating vehicle. In one example, the processing system (e.g., a fleet management system) may continue to communicate with either or both of the first surface-operating vehicle and the second surface-operating vehicle to monitor the in-motion wireless charging event until completion. In one example, the processing system may further transmit at least one instruction to at least one controllable roadway resource. For instance, the first surface-operating vehicle and/or the second surface-operating vehicle may be granted access to a special lane for the in-motion wireless charging (e.g., an HOV lane, a premium access lane, etc.), e.g., without additional charge or at a reduced rate, without incurring a violation, or the like. For example, roadway sensors may detect the lane-level presence of vehicles for usage billing, charging violations, etc. Alternatively, or in addition, the vehicles may be granted access/usage of a reserved toll booth/lane, and so forth. In one example corresponding instructions may be also be sent to the vehicles, e.g., to inform the vehicles that the premium lane and/or toll usage is permitted, etc. In various other examples, the method 200 may further include or may be modified to comprise aspects of any of the above-described examples in connection with FIG. 1, or as otherwise described in the present disclosure. Thus, these and other modifications are all contemplated within the scope of the present disclosure.

In addition, although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the example embodiments of the present disclosure.

FIG. 3 depicts a high-level block diagram of a computing device or processing system specifically programmed to perform the functions described herein. For example, any one or more components or devices illustrated in FIG. 1 or described in connection with the example(s) of FIG. 2 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for navigating a first surface-operating vehicle in synchronization with a second surface operating vehicle to provide wireless charging to the second surface-operating vehicle while in motion, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner fora particular illustrative example, i.e., the steps of the above method(s) or the entire method(s) are implemented across multiple or parallel computing devices, e.g., a processing system, then the computing device of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for navigating a first surface-operating vehicle in synchronization with a second surface operating vehicle to provide wireless charging to the second surface-operating vehicle while in motion (e.g., a software program comprising computer-executable instructions) can be loaded into memory 304 and executed by hardware processor element 302 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for navigating a first surface-operating vehicle in synchronization with a second surface operating vehicle to provide wireless charging to the second surface-operating vehicle while in motion (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor of a first surface-operating vehicle, a request for wireless charging of a second surface-operating vehicle while in motion;
navigating, by the processing system, the first surface-operating vehicle in synchronization with the second surface-operating vehicle; and
providing, by the processing system, the wireless charging to the second surface-operating vehicle while in motion.

2. The method of claim 1, wherein the first surface-operating vehicle is attached to the second surface-operating vehicle during the providing of the wireless charging.

3. The method of claim 2, further comprising:
attaching the first surface-operating vehicle to the second surface-operating vehicle.

4. The method of claim 2, wherein the first surface-operating vehicle is attached to the second surface-operating vehicle via at least one latch.

5. The method of claim 1, wherein the navigating comprises matching a speed and a direction of movement of the second surface-operating vehicle.

6. The method of claim 5, further comprising:
obtaining speed information and direction of movement information of the second surface-operating vehicle.

7. The method of claim 1, wherein the request includes information for navigating the first surface-operating vehicle to synchronize with the second surface-operating vehicle.

8. The method of claim 1, wherein the request includes information for accessing a wireless charging unit of the second surface-operating vehicle.

9. The method of claim 1, wherein the wireless charging comprises:
an induction charging; or
a resonant charging.

10. The method of claim 1, wherein the request is received from the second surface-operating vehicle.

11. The method of claim 1, further comprising:
transmitting an acceptance of the request.

12. The method of claim 1, wherein the first-surface operating vehicle is one of a fleet of surface-operating vehicles for providing in-motion wireless charging.

13. The method of claim 12, wherein the request is received from a fleet management system of the fleet of surface-operating vehicles.

14. The method of claim 1, wherein a length of the first surface-operating vehicle is less than ten feet, wherein a width of the first surface-operating vehicle is less than 7 feet; and wherein a height of the first surface-operating vehicle is less than 12 inches.

15. The method of claim 1, wherein the first surface-operating vehicle is positioned underneath the second surface-operating vehicle during the providing of the wireless charging.

16. The method of claim 1, wherein the first surface-operating vehicle comprises a charging module, wherein the providing of the wireless charging to the second surface-operating vehicle comprises deploying the charging module.

17. The method of claim 16, wherein the charging module is a tethered charging module, a remote-controlled charging module, or a self-operating charging module.

18. The method of claim 16, wherein the first surface-operating vehicle leads or follows the second surface-operating vehicle during the providing of the wireless charging.

19. A non-transitory computer-readable medium storing instructions which, when executed by a processing system including at least one processor of a first surface-operating vehicle, cause the processing system to perform operations, the operations comprising:
obtaining a request for wireless charging of a second surface-operating vehicle while in motion;
navigating the first surface-operating vehicle in synchronization with the second surface-operating vehicle; and
providing the wireless charging to the second surface-operating vehicle while in motion.

20. An apparatus comprising:
a processing system including at least one processor; and
a computer-readable medium storing instructions which, when executed by the processing system when deployed in a first surface-operating vehicle, cause the processing system to perform operations, the operations comprising:
obtaining a request for wireless charging of a second surface-operating vehicle while in motion;
navigating the first surface-operating vehicle in synchronization with the second surface-operating vehicle; and
providing the wireless charging to the second surface-operating vehicle while in motion.
